(19) United States
(12) Patent Application Publication
(10) Pub. No.: US 2014/0109995 A1
(43) Pub. Date: Apr. 24, 2014

(54) Mass Flow Controller Driven by Smart Material Actuator with Mechanical Amplification

(71) Applicant: Jeffery B. Moler, Sarasota, FL (US)

(72) Inventor: Jeffery B. Moler, Sarasota, FL (US)

(73) Assignee: Viking AT, LLC, Sarasota, FL (US)

(21) Appl. No.: 14/125,245

(22) PCT Filed: Jul. 2, 2012
(86) PCT No.: PCT/US2012/045249

§ 371 Date: Dec. 10, 2013

Related U.S. Application Data
(60) Provisional application No. 61/504,174, filed on Jul. 2, 2011.

(51) Int. Cl. G05D 7/06

(52) U.S. Cl. CPC G05D 7/0635
USPC 137/487.5

(57) ABSTRACT

An improved mass flow controller with a body having an inlet and an outlet; a sensor adapted to sense the flow of material out of the outlet; a controller adapted to receive a signal from the sensor; a proportional valve operatively connected between the inlet and the outlet; and a mechanically-amplified smart material actuator electrically connected to the controller and operatively connected to the proportional valve. The mechanically-amplified actuator comprises a smart material device, a compensator, a movable supporting member, at least two mechanical webs, at least two actuating arms, and a second stage assembly.

### CROSS-REFERENCE TO RELATED APPLICATIONS

This application claims priority from U.S. provisional patent application Ser. No. 61/504,174 filed Jul. 2, 2011, which is herein incorporated by reference in its entirety.

### BACKGROUND

The present invention relates to mass flow controllers driven by piezoelectric or smart material actuators. Piezoelectric mass flow controllers are known in the art. However, the flow capacity of such actuators is limited by the expansion characteristics of the piezoelectric stack used to drive the mass flow controller. The present invention overcomes this limitation through utilization of a smart material actuator with mechanical amplification. The mechanical amplification allows for the manufacture of smart material actuated mass flow controllers with greatly enhanced flow characteristics.

Mass flow controllers are devices adapted to help meter the flow of gasses or liquids. A typical mass flow controller will comprise a body having an inlet and an outlet, with flow between the inlet and outlet regulated by a proportional valve. Within the body, a sensor is adapted to sense the flow of material out of the outlet. In a typical embodiment, as the material flows through the body, it passes through a plenum. A diaphragm attached to a plunger is used to enlarge or shrink the volume of the plenum, thereby acting as a proportional valve and adjusting the rate of flow. The plunger is typically attached to an actuator that raises or lowers the plunger, or otherwise adjusts a proportional valve, based on signals received from a control circuit that is connected to the sensor.

Different types of actuators may be used to raise and lower the plunger or otherwise adjust the proportional valve as needed, including traditional electromagnetic actuators. Directly-driven piezoelectric actuators have also been used. Directly-driven piezoelectric actuators have the advantages of low power consumption, fast reaction time, and long duty cycles. They also have the advantage of being finely controllable, thereby enabling small and rapid adjustments to the plunger position. Such actuators, however, also have a disadvantage: small stroke length. Because the amount of expansion that will be achieved from a directly-driven piezoelectric actuator is limited by the size of the piezoelectric stack used, mass flow controllers utilizing such actuators are limited in the flow characteristics they can control. This is because the amount of movement of the plunger is limited to the amount of expansion of the piezoelectric stack. While larger stacks can be used to obtain somewhat higher stroke lengths, cost and physical size make it impractical to overcome this limitation merely by utilizing bigger stacks.

The present invention solves this problem by providing a mass flow controller that is driven by a smart material actuator having mechanical amplification. The mechanical amplification allows a smart material stack with a relatively small stroke length to drive an actuator with a greatly amplified stroke length. Preferred embodiments of actuators described herein can be manufactured with physical dimensions and electrical characteristics similar to those of directly-driven piezoelectric actuators used in prior art mass flow controllers. This allows for the reuse of existing mass flow controller parts such as bodies, sensors and controllers in mass flow controllers utilizing mechanically-amplified smart material actuators according to the present invention. Mechanically-amplified smart material actuators suitable for use in mass flow controllers according to the present invention also share the power usage, reaction speed, controllability, and longevity characteristics of directly-driven piezoelectric actuators, while still allowing for a greater stroke length.

This application hereby incorporates by reference, in their entirety, provisional applications 61/421,504 and 61/305,345, U.S. application Ser. Nos. 13/203,729 and 13/203,737 as well as PCT/US2011/25292, PCT/US2011/25299, PCT/US2011/64229 and PCT/US2011/64218 and U.S. Patents:
U.S. Pat. No. 6,717,332;
U.S. Pat. No. 6,548,938;
U.S. Pat. No. 6,737,788;
U.S. Pat. No. 6,836,056;
U.S. Pat. No. 6,879,087;
U.S. Pat. No. 6,759,790;
U.S. Pat. No. 7,132,781;
U.S. Pat. No. 7,126,259;
U.S. Pat. No. 6,870,305;
U.S. Pat. No. 6,975,061;
U.S. Pat. No. 7,564,171
U.S. Pat. No. 7,368,856; and
U.S. Pat. No. 6,924,586.

### SUMMARY

The present invention provides a mass flow controller comprising a body having an inlet and an outlet; a sensor adapted to sense the flow of material out of the outlet; a controller adapted to receive a signal from the sensor; a proportional valve operatively connected between the inlet and the outlet; and a mechanically-amplified smart material actuator electrically connected to the controller and operatively connected to the proportional valve. The actuator comprises a smart material device, a compensator, a movable supporting member, at least two mechanical webs, at least two actuating arms, and a second stage assembly connected to said actuating arms. The mechanical webs comprise an inner resilient member connected to the movable supporting member and an outer resilient member connected to an arm mounting surface. The compensator has a first mounting surface and the movable supporting member has a second mounting surface opposed and substantially parallel to the first mounting surface, and the smart material device is affixed within the compensator, between the first mounting surface and the second mounting surface. The actuating arms have a first actuating arm end attached to an arm mounting surface and an opposed second actuating arm end attached to the second stage assembly. The second stage assembly comprises resilient component with a mounting means.

Application of an electrical potential by the controller causes the smart material device to expand substantially without angular movement, thereby urging the movable supporting member away from the first mounting surface and causing the resilient members to flex. The flexing moves the actuating arms toward the smart material device, thereby causing the second stage resilient component to urge the mounting means in a direction substantially parallel to said smart material device. The motion of the mounting means is thus across a distance greater than the expansion of the smart material device and adjusting said proportional valve to increase or decrease the flow of material out of said outlet based on said signal.

### BRIEF DESCRIPTION OF THE DRAWINGS

Other objectives and features of the present invention will become apparent from the attached drawings, which illustrate certain preferred embodiments of the apparatus of this invention, wherein

FIG. 1 is a perspective view of an embodiment of a prior art mass flow controller utilizing a directly-driven piezoelectric actuator, with a portion of the cover removed;

FIGS. 2A and 2B are detail, cut-away views of portions of the embodiment shown in FIG. 1, illustrating the plenum and the plunger and diaphragm utilized to change the volume of the plenum, thereby forming a proportional valve;

FIG. 3 is a perspective view of the directly-driven piezoelectric actuator utilized in the embodiment illustrated in FIG. 1;

FIG. 4 is a sectional view of the directly-driven piezoelectric actuator shown in FIG. 3, also showing the connection to the plunger that is moved to adjust the volume of the plenum;

FIG. 5 is a perspective view of a preferred embodiment of a mass flow controller according to the present invention utilizing a mechanically-amplified smart material actuator;

FIGS. 6A and 6B are detail, sectional views of portions of the embodiment shown in FIG. 5, illustrating the plenum and the plunger and diaphragm utilized to change the volume of the plenum, thereby forming one type of proportional valve;

FIG. 7 is a perspective, sectional view of portions of the embodiment shown in FIG. 5, illustrating the interface between the mechanically-amplified smart material actuator and the plunger, as well as the plenum and diaphragm;

FIG. 8 is a further perspective, sectional view of the embodiment shown in FIG. 5, illustrating certain internal components of the mechanically-amplified smart material actuator illustrated in FIG. 7;

FIG. 9 is an exploded perspective view of the internal components of the mechanically-amplified actuator embodiment illustrated in FIG. 7;

FIG. 10 is a perspective view of certain of an alternate embodiment of a mechanically-amplified smart material actuator suitable for use with the mass flow controller embodiment illustrated in FIG. 5;

FIG. 11 is a perspective, sectional view of certain internal components of the alternate embodiment of a mechanically-amplified smart material actuator illustrated in FIG. 10;

FIG. 12 is an exploded, perspective view of the embodiment of a mechanically-amplified smart material actuator illustrated in FIG. 10;

FIG. 13 is a perspective, sectional view of certain internal components of the further alternate embodiment of a mechanically-amplified smart material actuator suitable for use with the mass flow controller embodiment illustrated in FIG. 5 in which no preload screw is utilized;

FIG. 14 is a side sectional view of an alternate embodiment of a mechanically-amplified smart material actuator driven mass flow controller in which the means of adjusting the proportional valve does not use a plunger to transfer movement to a diaphragm;

FIG. 15 is a perspective view of the mechanically-amplified smart material actuator utilized in the embodiment shown in FIG. 14;

FIG. 16 is a further perspective view of the mechanically-amplified smart material actuator utilized in the embodiment shown in FIG. 14;

FIG. 17 is perspective, sectional view of an embodiment of a mechanically-amplified smart material actuator suitable for use in embodiments of the mass flow controller of the present invention in which the proportional valve is normally closed; and

FIG. 18 is a detail sectional view of a portion of the embodiment illustrated in FIG. 17 showing the second stage assembly and plunger and diaphragm components of the proportional valve.

### DETAILED DESCRIPTION

While the following describes preferred embodiments of this invention with reference to the included figures, it is to be understood that this description is to be considered only as illustrative of the principles of the invention and is not to be limitative thereof, as numerous other variations, all within the scope of the invention, will readily occur to others in light of the disclosure in this detailed description.

Herein, it will also be understood that in the illustrated embodiments, different embodiments comprise the same or similar components. Where the same component is suitable for use in different embodiments, the same reference number may be used. For example, and without limitation, actuating arm 364 is illustrated as a common component that may be used in embodiments of mechanically-amplified smart material actuators including 340 and 340a. Accordingly, the same number is used to indicate the common part used in the illustration of each assembly. Where components in different embodiments have a comparable structure, but are not necessarily common or identical parts, a similar number is used, but with a differing initial first digit, but common second and third digits. For example, and without limitation, compensators 344 and 444 are examples of compensators with similar structures adapted for use in different embodiments of mechanically-amplified smart material actuators 340 and 440 of the apparatus of the present invention, but need not be interchangeable parts.

Herein, the following terms shall have the following meanings:

The term “adapted” shall mean sized, shaped, configured, dimensioned, oriented and arranged as appropriate.

The term “smart material device” shall mean a device comprising a piezoelectric material that expands when an electric potential is applied, or that generates an electric charge when a mechanical force is applied. Smart material devices include, without limitation, devices formed of alternating layers of ceramic piezoelectric material fired together (a so-called co-fired multilayer ceramic piezoelectric stack such as those available from suppliers including NEC) and devices formed of one or more layers of material cut from single crystal piezoelectric materials. In the foregoing, the term “piezoelectric material” also includes so-called “smart materials,” sometimes created by doping known piezoelectric materials to change their electrical or mechanical properties.

The term “mechanical web” shall mean a structure comprising at least two resilient members and being adapted to translate motion to an actuating arm. Under normal operating conditions, the resilient members will flex and then return to their original configuration. Mechanical webs may be formed from a variety of materials, including, without limitation steel, stainless steel, invar, certain ceramics and plastics, and aluminum. The size, and in particular the length and thickness, of the resilient members will partly determine the amount of motion that can be applied to an actuating arm, and will thus influence the choice of materials.

The term “activation” when used in conjunction with “actuator” or “smart material device” means application of an electrical potential and current suitable to cause the smart material device (or the smart material device within an actuator) to expand in an amount sufficient to flex the resilient members of at least one mechanical web, thus imparting movement to an actuating arm.

The definitions and meanings of other terms herein shall be apparent from the following description, the figures and the context in which the terms are used.

### DESCRIPTION OF PREFERRED EMBODIMENTS

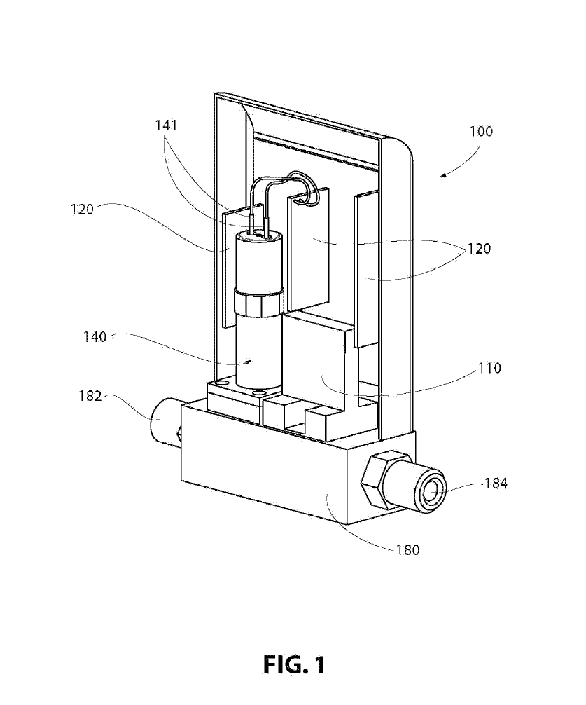

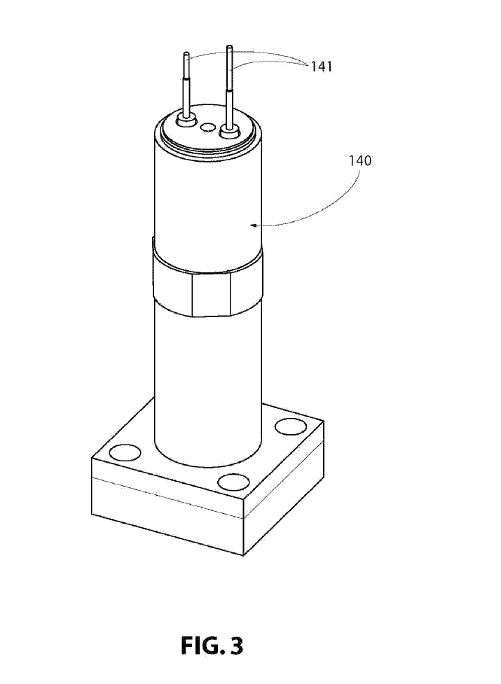

FIGS. 1-4 illustrate an embodiment of a directly-driven, piezoelectric mass flow controller (“MFC”) as is known in the art. The embodiment illustrated is similar to the SEC 4400 MFC available from HORIBA STEC. Generally, MFC 100 comprises body 180 having inlet 184 and outlet 182. A gas or liquid material (hereinafter the “Material”) (not illustrated) enters into the inlet 184 under some amount of pressure. MFC 100 then regulates the flow of the Material such that a controlled amount of the Material exits the outlet 182.

Sensor 110 comprises a means to sense (not illustrated) the amount of Material flowing at any given time. Various means to sense flow are known in the art and sensor 110 is illustrated in block form only. Any sensor 110 capable of generating an appropriate signal may be utilized. Sensor 110 provides a sensor signal to controller 120. Controller 120 may be electronic circuitry and may be preset to a given flow rate (often in terms of a percentage of maximum flow possible), or may receive a signal from an external source (not illustrated) directing controller 120 to adjust the flow rate from time to time. Control circuits suitable for use with controller 120 are known in the art and not described further herein. As with sensor 110, controller 120 is illustrated only in block form.

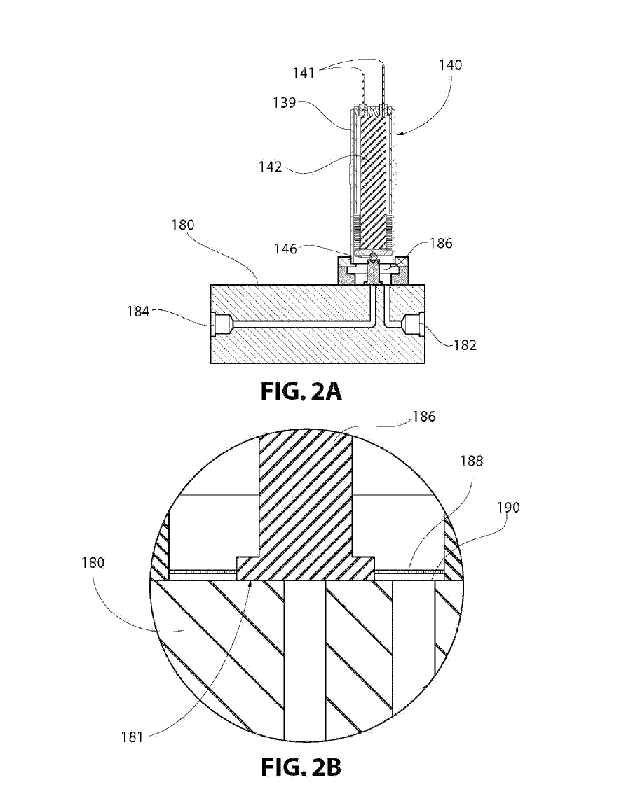

Directly-driven smart material actuator 140 is electrically connected to controller 120 through electrodes 141 and provides the mechanical action necessary to adjust a proportional valve and thereby achieve flow regulation. As illustrated in FIGS. 2A and 2B, this may be accomplished by routing the Material from inlet 184 into a plenum 190, the volume of which can be adjusted by directly-driven smart material actuator 140, from which the Material may be routed to outlet 182. The adjustable plenum 190 thereby creates an embodiment of a proportional valve 181. The flow of the Material is thus controlled by making plenum 190 larger (thereby increasing flow) or smaller (thereby decreasing flow) as necessary. It will be understood that other types of proportional valves known in the art may also be used, and that proportional valve 181 is just one example of an appropriate embodiment.

While various means of adjusting the volume of plenum 190 may be used, one convenient method is to have plunger 186 attached to (or integral with) a diaphragm 188. As plunger 186 is raised (in the case of directly-driven smart material actuator 140 by the contraction of smart material device 142), diaphragm 188 retracts, causing the volume of plenum 190 increases, and as plunger 186 is lowered (in the case of directly-driven smart material actuator 140 by the expansion of smart material device 142), diaphragm 188 lowers, causing the volume of plenum 190 to decrease. It is apparent, therefore, that flow characteristics of MFC 100 are dependent upon the minimum and maximum volume achievable in plenum 190, and that the volume achievable in plenum 190 is dependent upon the amount of movement (or stroke) available from directly-driven smart material device 142. As, in a typical embodiment, plenum 190 will have only a very small height (0.002 inches as shown) in the fully expanded state, the possible flow characteristics achievable with such embodiments can be rather limited.

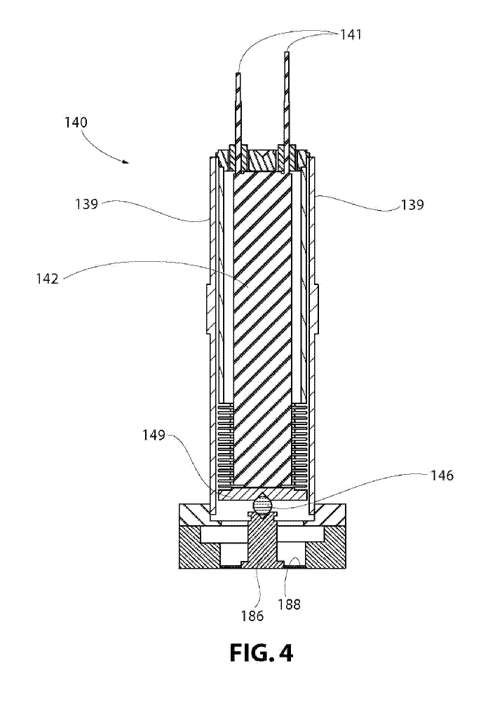

The low height is a result of the limited stroke-length of directly-driven smart material actuator 140 used in MFC 100. A typical embodiment of a directly-driven smart material actuator is illustrated in FIG. 4. Smart material device 142 is housed within actuator cover 139. When a suitable electric potential and current is applied to electrodes 141, smart material device 142 expands, pushing directly down on base plate 149. The amount of stroke can be manipulated to some degree by manipulating the power signal applied to electrodes 141. Base plate 149 is mechanically attached to plunger 186. The attachment may be accomplished by a variety of means provided, however that the connection is suitably rigid, thereby allowing for quick reaction times. One means of connection is to insert a ball 146 of a very hard substance (such as, without limitation, a ruby ball) between base plate 149 and the top of plunger 186, with cavities in both to help keep ball 146 in place during operation. As can be seen, in such embodiments, the stroke of plunger 186 will be equal to the stroke length of smart material device 142. If a longer stroke length is needed, a larger smart material device 142 must be used. Using larger devices, however, increases the cost and size of MFC 100.

The present invention addresses this limitation by allowing for longer stroke lengths achieved by the use of a mechanically-amplified smart material actuator instead of a directly-driven piezoelectric actuator. Other than adjustments in the control circuitry and plenum components to account for the larger plenum volume achievable, the remaining components of the MFC are largely unchanged.

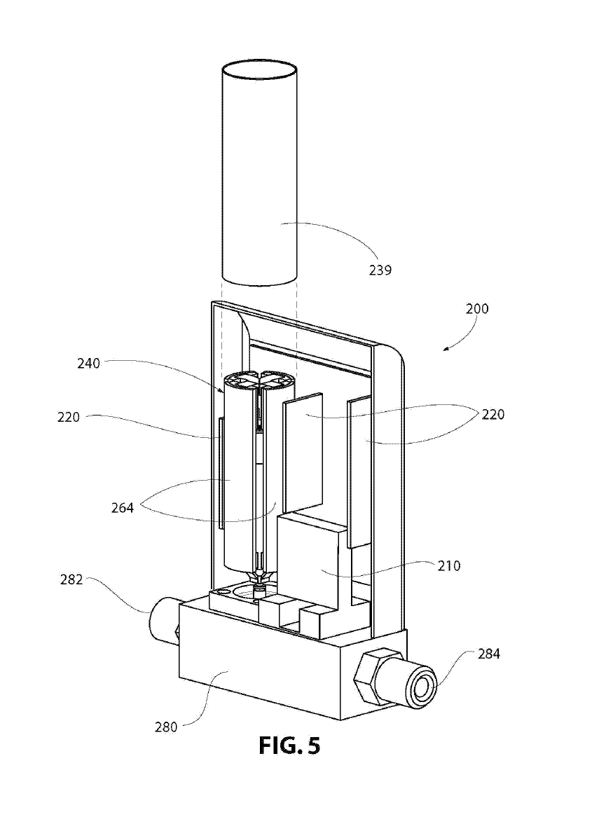

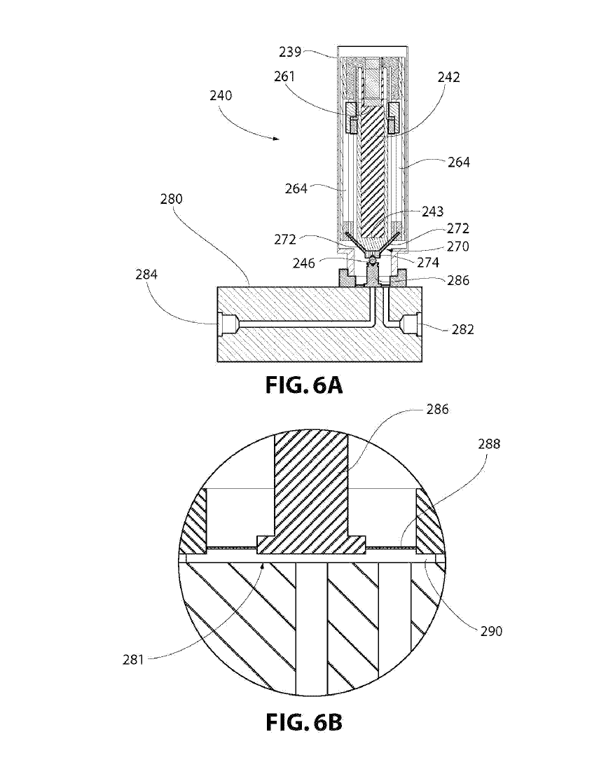

Referring to FIGS. 5-7, a preferred embodiment of MFC 200 according to the present invention is illustrated. Body 280 has inlet 284 and outlet 282. Sensor 210 is adapted to monitor the flow of Material out of outlet 282 and to provide a sensor signal to controller 220 which, in turn, activates and deactivates mechanically-amplified smart material actuator 240 to adjust the flow as needed. As with the prior art embodiment previously described, controller 220 and sensor 210 are illustrated only in block form, and are not described in detail, as they are components known in the art. As has been described, flow adjustment is accomplished by routing Material from inlet 284 through an adjustable valve assembly 281. As illustrated, proportional valve assemble comprises a plenum 290. The volume of plenum 290 is adjusted by plunger 286, which is attached to (or integral with) a diaphragm 288. The difference between MFC 200 according to the present invention and prior art MFC 100, however, is that because mechanically-amplified smart material actuator 240 has a much greater stroke length than a comparable directly-driven smart material actuator, plenum 290 has a much greater height. In the embodiment illustrated, the height is 0.02 inches, or ten times greater than the height of plenum 190 previously described. It will be understood that the dimensions discussed herein are intended only to be exemplary of the present invention, and not limiting thereof, as many different sizes and configurations may be used, as will be apparent to those of ordinary skill in the art.

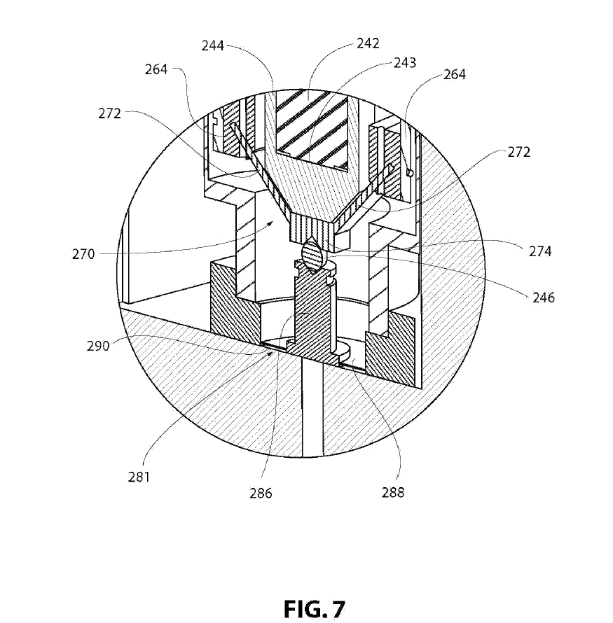

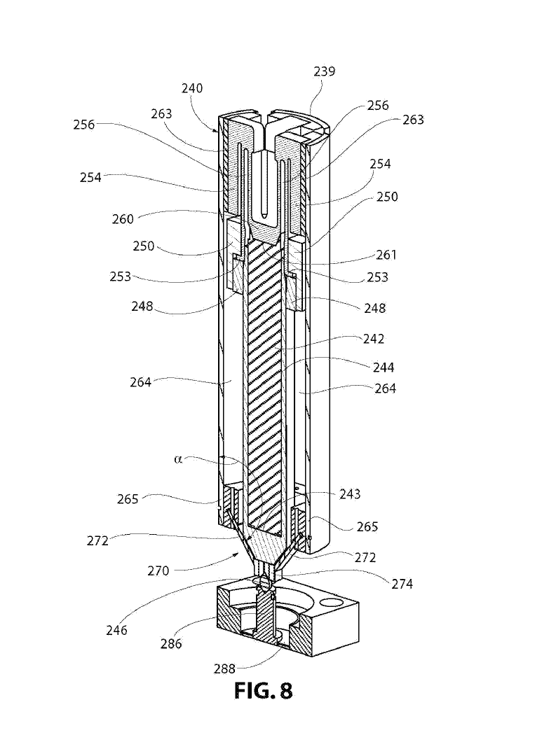

As is illustrated in FIGS. 7-8, the connection between mechanically-amplified smart material actuator 240 and plunger 286 is highly similar to the connection previously described, with rigid ball 246 in place between them. The key difference, however is that second stage mounting block 274 (described further below) provides the mounting surface for ball 246 instead of a base plate (such as base plate 149) as was described above.

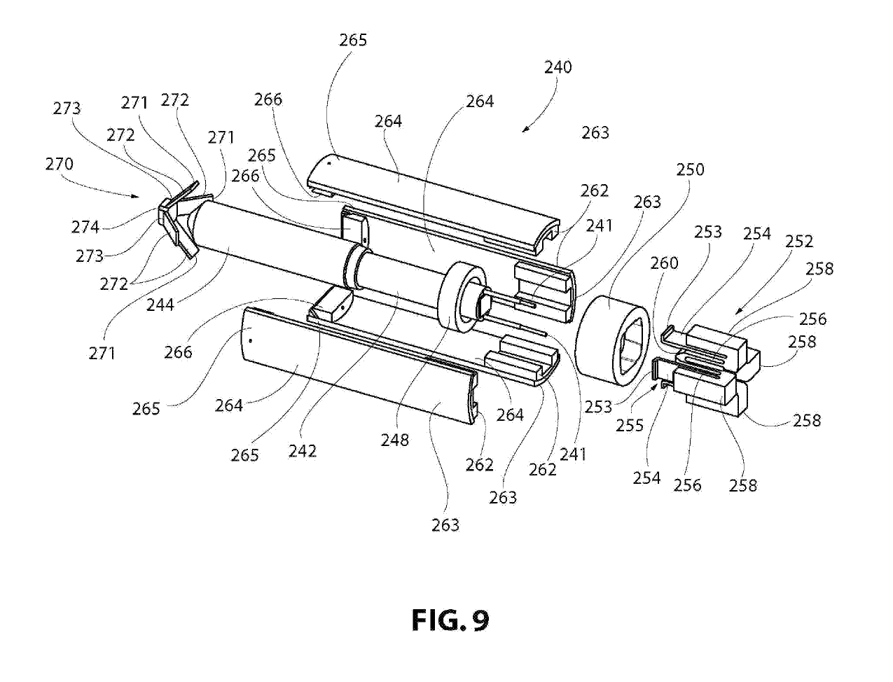

Internal components of a preferred embodiment of mechanically-amplified smart material actuator 240 suitable for use in embodiments of MFCs according to the present invention are further illustrated in FIGS. 8 and 9. In the embodiment illustrated, smart material device 242 provides the motive force. Electrodes 241 (see FIG. 9) receive a drive signal from controller 220 in the form of an electric potential and current, thereby activating smart material actuator 240. Application or suitable increase the drive signal causes smart material device 242 to expand, and removal or suitable reduction of the drive signal causes smart material device 242 to contract. Smart material device 242 is mounted within compensator 244, which may conveniently formed of invar, stainless steel or other suitable materials. Compensator securing ring 248 is attached to the base of compensator 244, which may conveniently be accomplished by press fitting or by making compensator securing ring 248 integral with compensator 244 or by utilizing other attachment means known in the art. In the illustrated embodiment, the outer surface of compensator securing ring 248 is preferably threaded (threads not illustrated) to allow compensator 244 to be threaded into web securing ring 250 during assembly. Web securing ring 250, may also be conveniently formed of invar, stainless steel, or other suitable materials known in the art and may conveniently have internal threads (not illustrated) adapted to receive compensator securing ring 248.

Mechanical webs 255, which also may conveniently be formed of stainless steel, comprise a movable supporting member 260 adapted to receive the base of smart material device 242 and preferably to allow electrodes 241 to pass through to the outside of mechanically-amplified smart material actuator 240. When assembled, smart material device 242 is fixed between first mounting surface 243 and second mounting surface 261 (on movable supporting member 260). As smart material device 242 expands, it thus presses against movable supporting member 260 and compensator 244. The mechanical connection between compensator 244 and mechanical webs 255 is such that compensator 244 remains in place while movable supporting member 260 moves in and out.

Movable supporting member 260 is connected to a plurality of inner resilient members 256, which are in turn connected to outer resilient members 254. Outer resilient members 254 are affixed to compensator 244, which may conveniently be accomplished by compressing a portion of outer resilient members 254 between compensator securing ring 248 and web securing ring 250. Thus, when assembled, compensator 244 holds outer resilient members 254 securely during operation. Tabs 253 may be used to further secure outer resilient members 254. Machining the base of compensator 244 with a slight angle will also help secure outer resilient members 254 when assembled as the threading or compression of compensator securing ring 248 onto web securing ring 250 will then assert pressure on a portion of outer resilient members 254.

As smart material device 242 expands, movable supporting member 260 is pushed back, applying pressure to inner resilient members 256. Because outer resilient members 254 are held securely by compensator 244, inner resilient members 256 and outer resilient members 254 flex. The flexing action causes actuating arm mounting surfaces 258 to move. Actuating arms 264 are attached to or integral to actuating arm mounting surfaces 258 proximate to first actuating arm ends 263. Such attachment may conveniently be made mechanically (for example and without limitation with mechanical fasteners (not illustrated) or with adhesives, epoxies or press fitting). As illustrated, actuating arms 264 are rounded to fit within the round actuator cover 239 of mechanically-amplified smart material actuator 240, and arm mounting spacers 262 may conveniently be used between actuating arms 264 and actuating arm mounting surfaces 258 to facilitate a secure connection. In this way, when smart material device 242 is activated, the flexing of inner resilient members 256 and outer resilient members 254 cause second actuating arm ends 265 of actuating arms 264 to move inward toward smart material device 242. Because of the length of actuating arms 264, the movement of second actuating arm ends 265 may be across a greater distance than the amount of expansion of smart material device 242.

To convert the inward motion of second actuating arm ends 265 to the downward motion needed to move plunger 286, second stage assembly 270 may conveniently be used. Second stage assembly 270 comprises second stage resilient members 272 attached to second actuating arm ends 265 proximate to first second stage resilient member ends 271. Second stage mounting spacers 266 may be used to facilitate the attachment. Second second stage resilient member ends 273 are connected to second stage mounting block 274. It will be understood that second stage mounting block 274 may be attached to second stage resilient member 272, or second stage mounting block 274 may be integral with second stage resilient member 272 (as is illustrated in FIG. 9), such as when second stage assembly 270 is formed from a single sheet of material. Spring steel, carbon fiber, stainless steel, or other resilient materials known in the art may be used for second stage resilient members 272 and second stage mounting block 274. As second actuating arm ends 265 are urged in, second stage mounting block 274 is urged down, converting the motion of actuating arms 264 into the linear motion appropriate to move plunger 286. Depending on the length and angle of second stage resilient members 272, second stage assembly 270 may also provide a further amplification of the expansion of smart material device 242.

By varying the length and resiliency of mechanical webs 255, the lengths of actuating arms 264, and the lengths and resiliency of second stage resilient members 272, embodiments of mechanically-amplified smart material actuator 240 may be adapted such that the mechanically-amplified movement of smart material actuator 240 (in particular as measured at second stage mounting block 274) is more than five times the amount of expansion of smart material device 242, or is more than ten times the amount of expansion of smart material device 242, or is more than one hundred times the amount of expansion of smart material device 242. In this way, varying degrees of mechanical amplification can be achieved and, in combination with the selection of smart material devices 242 having different expansion capabilities, mass flow controllers 200 of varying flow characteristics can be manufactured. Further characteristics of mechanically-amplified smart material actuator 240, mechanical webs 255, and second stage assembly 270 will be apparent from a review of the incorporated references.

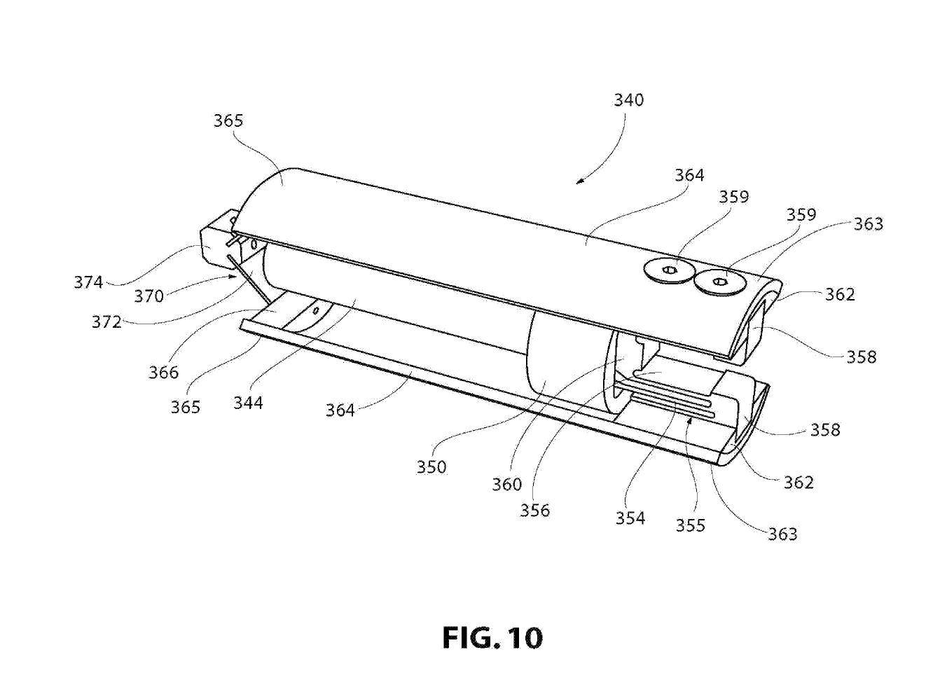

While the embodiment of mechanically-amplified smart material actuator 240 illustrated in FIGS. 8 and 9 comprises four actuating arms 264, embodiments with other numbers of actuating arms including, three arm and two arm embodiments, and embodiments having more than four arms are possible. For example, and without limitation, FIGS. 10-13 illustrate certain preferred two arm embodiments. Mechanically-amplified smart material actuators 340, 340a are highly similar to mechanically-amplified smart material actuator 240, previously described (and unlike directly-driven smart material actuator 140, are mechanically-amplified). Smart material device 342 is affixed within compensator 344, 344a, between first mounting surface 343 and second mounting surface 361 on movable supporting member 360 of mechanical webs 355. Inner resilient members 356 are attached to movable supporting member 360 and outer resilient members 354 (with optional tab 353), is held securely to compensator 344, 344a by web securing ring 350. Compensator securing ring 348 may be pressed onto compensator 344, 344a and then threaded into web securing ring 350 during assembly. Actuating arms 364 attach to actuating arm mounting surfaces 358, which may conveniently be accomplished with actuating arm mounting spacers 362 and mechanical fasteners 359 as shown. Second actuating arm ends 365 may be attached to second stage assembly 370 by mechanically attaching second stage mounting spacers 366 to second actuating arm ends 365 and first second stage resilient member ends 371. Pins 376 may be used. Second stage mounting block 374 may then be attached to second second stage resilient member ends 372, also conveniently utilizing pins 376. Activation of smart material device 342 will then urge movable supporting member 360 away from compensator 344, 344a, causing inner resilient members 356 and outer resilient members 354 to flex, thereby moving second actuating arm ends 365 toward smart material device 342. Second stage assembly 370 then converts that motion into substantially linear motion of second stage mounting block 374. Here again, mechanical amplification is achieved through mechanical webs 355, actuating arms 364 and second stage assembly 370.

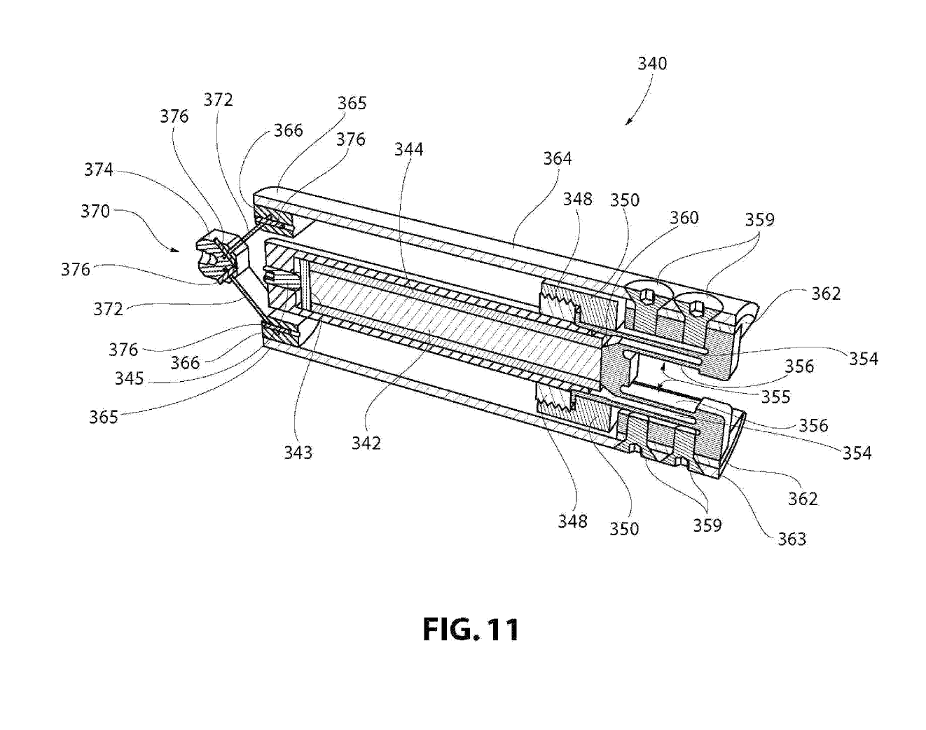

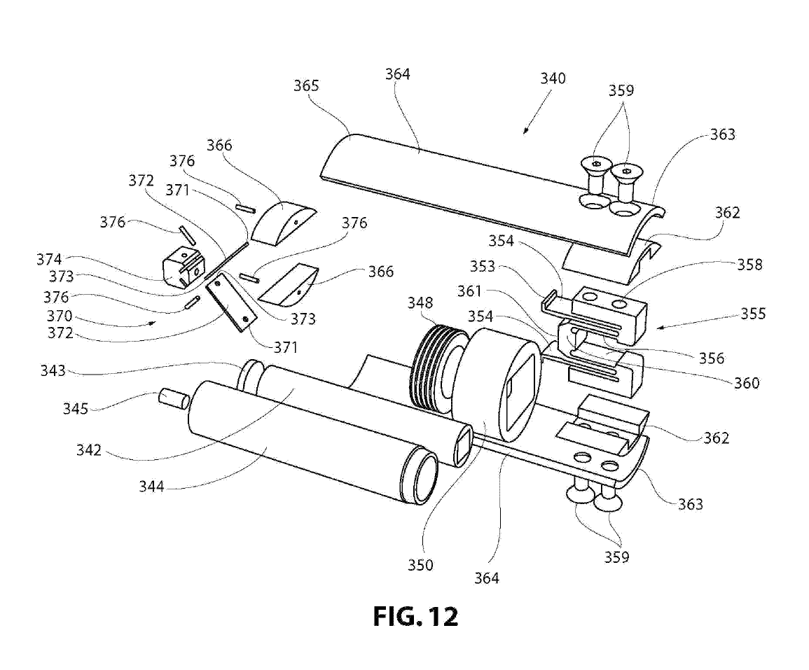

Pre-compressing (also referred to herein as preloading) smart material device 242, 342 can improve the efficiency of mechanically-amplified smart material actuators 240, 340, 340a. Referring to FIGS. 11 and 12, one convenient means of preloading smart material device 242, 342 is to utilize a preload screw 345, threaded through compensator 244, 344 to apply pressure to a compression plate that serves as the first mounting surface 243, 343, thereby preloading smart material device 242, 342 after assembly.

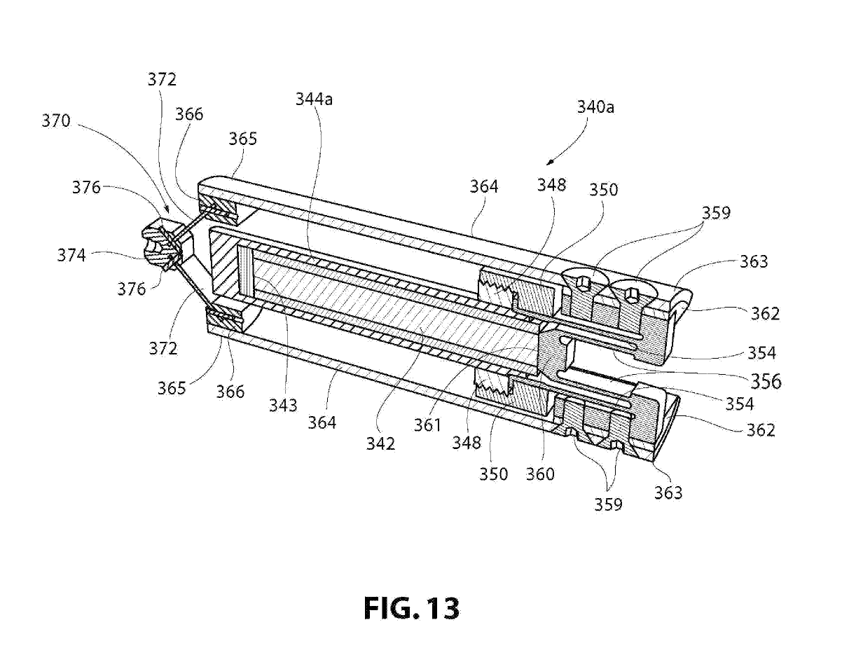

An alternate means of providing preload to smart material device 342 is illustrated in FIG. 13. In this embodiment, compensator 344a has no provision for a preload screw. Compensator 344a, however is threaded onto web mounting ring 350, as has been previously described. By selecting an appropriately sized spacer to serve as first mounting surface 343 and threading compensator 344a onto web securing ring 350 to predetermined position, a given preload may also be applied to smart material device 342 without the need for a preload screw.

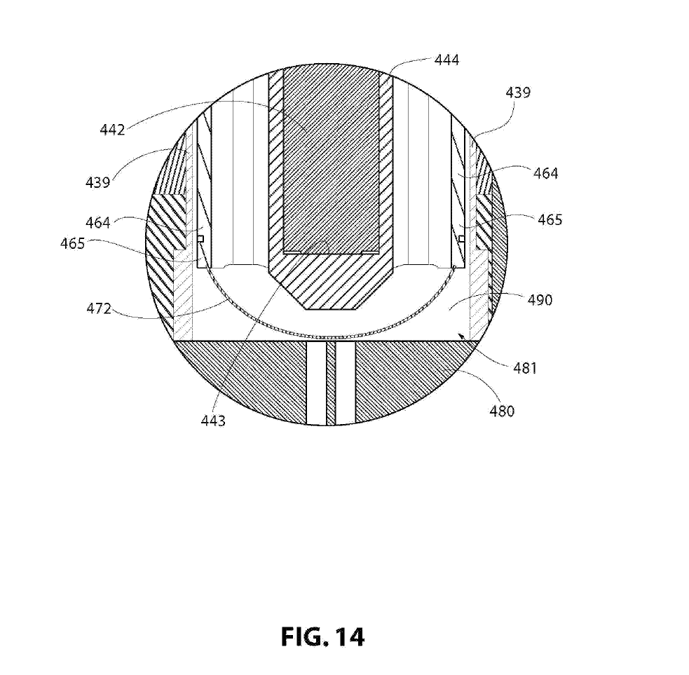

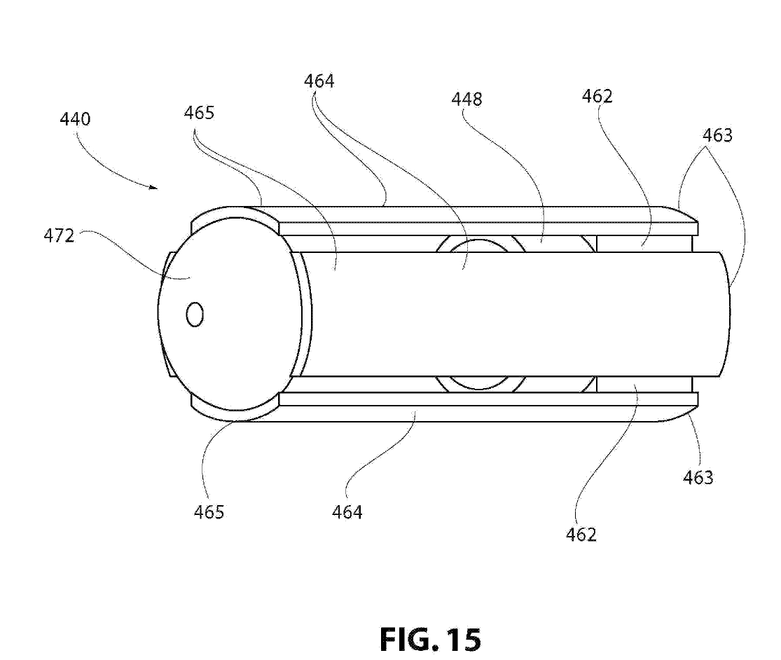

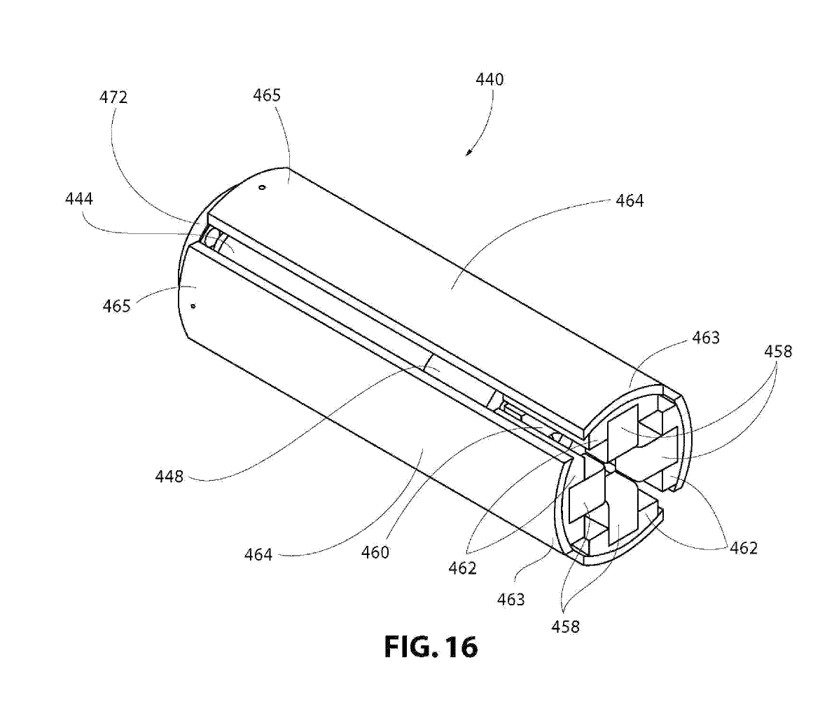

FIGS. 14-16 illustrate a further embodiment of a mechanically-amplified smart material actuator 440 suitable for use in MFCs according to the present invention. The mechanically-amplified smart material actuator 440 illustrated in FIGS. 14-16 is also highly similar to the previously described embodiments. Smart material device 442 is affixed within compensator 444 between first mounting surface 443 and a second mounting surface (not illustrated) on movable supporting member 460. Activation of smart material device 442 causes movement of actuating arms 464 which are mounted to actuating arm mounting surfaces 458 in the same manners as has previously been described. As is illustrated in FIG. 14, the key difference in such embodiments is that no plunger is used. Instead, a semi-spherical second stage resilient member 472 is formed of a resilient material and is attached directly to second actuating arm ends 465 of actuating arms 464. Semi-spherical second stage resilient member 472 thus takes the place of the diaphragms discussed in connection with previous embodiments. As mechanically-amplified smart material actuator 440 is activated, second actuating arm ends 465 move as smart material device 442 expands and contracts. That movement changes the shape of semi-spherical second stage resilient member 472, thereby adjusting the volume and/or shape of plenum 490, enabling the combination of semispherical second stage resilient member 472 and plenum 490 to function as a proportional valve controlling the flow of Material through MFC 400, as has been previously described. Otherwise MFC 400, comprising controller 420, sensor 410, and body 480 (having inlet 484 and outlet 482) operates in the same manner as has been described in connection with previous embodiments. The attachment of semispherical second stage resilient member 472 to actuating arms 464 may be through any variety of means known in the art including, without limitation, pins or other mechanical fasteners or adhesives. Additional sealing means (not illustrated) may also be utilized to control the volume of plenum 490 by creating an additional seal between semispherical second stage resilient member 472 and actuator cover 439 or, in some embodiments between semispherical second stage resilient member 472 and body 480. Semispherical second stage resilient member 472 may be formed of a variety of materials including, without limitation, metals (such as, without limitation, steel, spring steel, stainless steel, and aluminum), carbon fiber, plastic, rubber and the like. Provided the material is resistant to the Material, and resilient, and can flex upon application of the force generated by mechanically-amplified smart material actuator 440, any such material could be suitable. Given the shape of semispherical second stage resilient member 472, however, it is preferably utilized with mechanically-amplified smart material actuators having three or more arms.

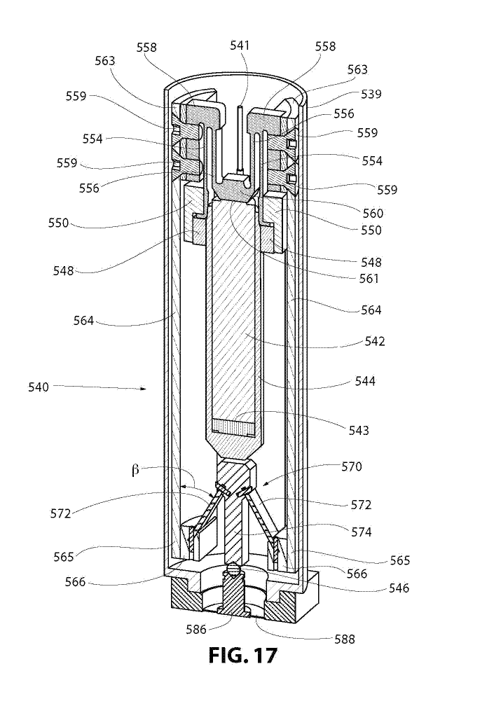

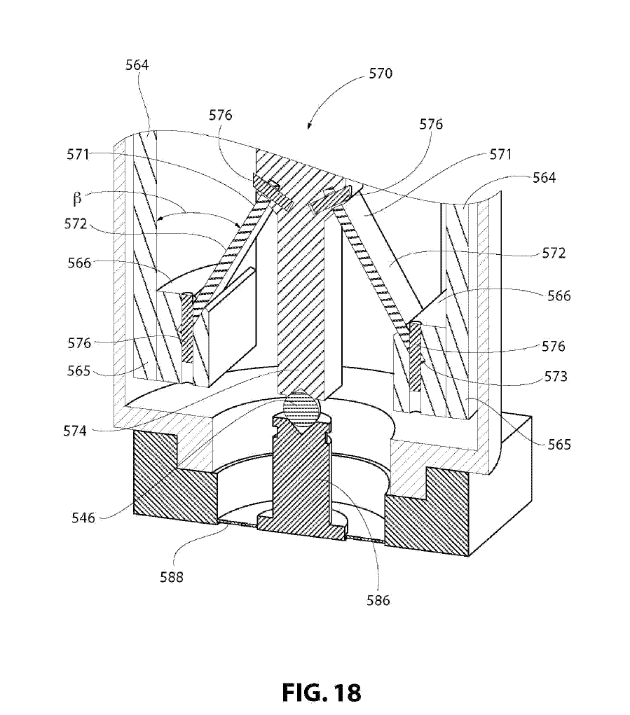

The embodiments previously described are adapted such the MFC 200, 300, 400 are normally open, allowing Material to flow at the maximum rate, unless and until mechanically-amplified smart material actuator 240, 340, 440 is activated to reduce the flow. The present invention, however, is not limited to normally open MFC embodiments and can work equally well with embodiments of MFCs that are normally in a closed position by varying the design of the mechanically-amplified smart material actuator. FIGS. 17 and 18 illustrate an embodiment of a mechanically-amplified smart material actuator 540 convenient for use in embodiments of MFCs that are normally closed. As illustrated the basic structure of mechanically-amplified smart material actuator 540 is highly similar to mechanically-amplified smart material actuator 240 illustrated in FIG. 8. Smart material device 542 is affixed within compensator 544 between first mounting surface 543 and second mounting surface 561 on movable supporting member 560. Inner resilient members 556 and outer resilient members 554 flex upon activation of smart material device 542 to impart movement to actuating arms 564, with actuating arm mounting and compensator attachment characteristics being substantially identical to those previously described. Second stage assembly 570, however is adapted such that inward motion of second actuating arm ends 565 retracts second stage mounting block 574, instead of extending it. Such action may conveniently be accomplished by adapting second stage mounting block 574, and second stage mounting spacers 566 such that the angle β between actuating arms 564 and second stage resilient members 572 is less than ninety degrees. In such configurations, inward motion of second actuating arm ends 565 will urge second stage mounting block 574 toward smart material device 542. In contrast, and referring to FIG. 8, when the angle α between actuating arms 264 and second stage resilient members 272 is greater than ninety degrees, then the action is reversed and inward motion of second actuating arm ends 265 urge second stage mounting block 274 away from smart material device 242. Referring again to FIGS. 17 and 18, it can be seen that in embodiments in which angle β is less than ninety degrees, additional space is needed between compensator 544 and plunger 586. This can be accomplished by using longer actuating arms 564, or by using shorter compensator 544 and smart material device 542. The mechanical connection between second stage mounting block 574 and ball 546 then may be adapted to account for the increased space by any number of means that will be apparent to those of ordinary skill in the art. One convenient method is to extend second stage mounting block 574 as shown. Other methods include, without limitation, using spacers and increasing the size of plunger 586 to account for the additional space. In this way, plunger 586 and diaphragm 588 can be adapted such that the size of the plenum (not illustrated) formed in part by diaphragm 588 is very small or zero until smart material device 542 is activated and diaphragm 588 is raised. As will be apparent, in such embodiments, either the pressure of the Material, or the spring action of diaphragm 588 will act to raise diaphragm 588 as second stage mounting block 574 retracts. Otherwise, second stage mounting block 574 may be affixed to plunger 588 (including without limitation through the use of mechanical fasteners, epoxies or adhesives) such that the connection is adapted to enable second stage mounting block 574 to exert an upward force on plunger 586 when no upward pressure is being exerted by diaphragm 588. It will also be understood by those of ordinary skill in the art that other types of proportional valve may be substituted for proportional valve 581 formed by plunger 586, diaphragm 588, and the plenum (not illustrated in FIG. 18) provided the operating characteristics of the valve are reasonably consistent with the stroke characteristics of the mechanically-amplified smart material actuator 540, or, as discussed in the previously illustrated embodiments, mechanically-amplified smart material actuators 240, 340, 440.

It can thus be seen that the present invention discloses a mass flow controller comprising: (a) a body having an inlet and an outlet; (b) a sensor adapted to sense the flow of material out of said outlet; (c) a controller adapted to receive a signal from said sensor; (d) a proportional valve operatively connected between said inlet and said outlet; (d) a mechanically-amplified smart material actuator electrically connected to said controller; and operatively connected to said proportional valve said actuator, comprising a smart material device, a compensator, a movable supporting member at least two mechanical webs at least two actuating arms and a second stage assembly connected to said actuating arms wherein (i) said compensator has a first mounting surface, (ii) said mechanical webs comprise an inner resilient members connected to said movable supporting member and an outer resilient member connected to an arm mounting surface; (iii) said movable supporting member comprises a second mounting surface opposed and substantially parallel to said first mounting surface, (iv) said actuating arm comprises a first actuating arm end attached to one said arm mounting surface and an opposed second actuating arm end; (v) said smart material device is affixed within said compensator between said first mounting surface and said second mounting surface; and (vi) said second stage assembly comprises at least one second stage resilient member having a first second stage resilient member end attached to said second actuating arm end and a second second stage resilient member end attached to a second stage mounting block; whereby application of an electrical potential by said controller causes said smart material device to expand substantially without angular movement, thereby urging said movable supporting member away from said first mounting surface and causing said resilient members to flex, thereby moving said actuating arms toward said smart material device, thereby causing said second stage resilient members to urge said second stage mounting block in a direction substantially parallel to said smart material device such that motion of said second stage mounting block is across a distance greater than the expansion of said smart material device and adjusting said proportional valve, to increase or decrease the flow of material out of said outlet based on said signal.

Embodiments of such mass flow controllers are possible wherein said actuator comprises two actuating arms. Embodiments are also possible wherein said actuator comprises three actuating arms and wherein said actuator comprises more than three actuating arms.

It will also be understood that such mass flow controllers are possible wherein said second stage mounting block is integral with said second stage resilient members, and wherein said second stage mounting block is mechanically attached to said second stage resilient members.

It will further be understood that such mass flow controllers are possible wherein the angle between said actuating arms and said second stage resilient members is greater than ninety degrees such that activation of said actuator causes said second stage mounting block to move away from said smart material device; and wherein the angle between said actuating arms and said second stage resilient members is less than ninety degrees such that activation of said actuator causes said second stage mounting block to move toward said smart material device.

In addition, such mass flow controllers are possible wherein (a) said proportional valve comprises a plunger operatively connected to a diaphragm; (b) said plunger has a first plunger end in operative mechanical connection with said second stage mounting block and a second plunger end in operative mechanical connection with said diaphragm; and (c) said diaphragm forms a portion of a plenum; whereby said plenum volume may be adjusted by causing said actuator to compress said plunger, thereby adjusting the rate of flow of material through said proportional valve. In such embodiments, said diaphragm may, in some cases, be formed of metal.

It can further be seen that the present invention discloses a mass flow A mass flow controller comprising: (a) a body having an inlet and an outlet; (b) a sensor adapted to sense the flow of material out of said outlet; (c) a controller adapted to receive a signal from said sensor; (d) a mechanically-amplified smart material actuator electrically connected to said controller; (e) a semi-spherical second stage operatively connected to said actuator and adapted to form a portion of a plenum having adjustable volume, said plenum being operatively connected to said inlet and said outlet; wherein said controller causes said actuator to adjust the volume of said plenum based on said signal from said sensor whereby said mass flow controller is adapted to control a flow of material from said inlet through said outlet.

Embodiments of such mass flow controllers are possible wherein said actuator comprises a smart material device, a compensator, a movable supporting member, at least two mechanical webs, at least two actuating arms, and a second stage assembly connected to said actuating arms wherein (a) said compensator has a first mounting surface, (b) said mechanical webs comprise an inner resilient member mechanically connected to said movable supporting member, and an outer resilient member connected to an arm mounting surface; (c) said movable supporting member comprises a second mounting surface opposed and substantially parallel to said first mounting surface; (d) said actuating arms comprise a first actuating arm end attached to one said arm mounting surface and an opposed second actuating arm end; (e) said smart material device is affixed within said compensator, between said first mounting surface and said second mounting surface; and (f) said semispherical second stage comprises a semi-spherical diaphragm operatively attached to said second actuating arm ends. In such mass flow controllers, said actuator may conveniently comprise three actuating arms or more than three actuating arms.

It can still further be seen that the present invention discloses a mass flow controller comprising: (a) a body having an inlet and an outlet; (b) a sensor adapted to sense the flow of material out of said outlet; (c) a controller adapted to receive a signal from said sensor; (d) a mechanically-amplified smart material actuator electrically connected to said controller, said smart material actuator comprising a smart material device and being adapted such that the mechanically-amplified movement of said smart material actuator is more than five times the amount of expansion of said smart material device; and (e) a proportional valve mechanically connected to said actuator and being operatively connected to said inlet and said outlet; wherein said controller causes said actuator to adjust said valve based on said signal from said sensor whereby said mass flow controller is adapted to control a flow of material from said inlet through said outlet.

Such mass flow controllers are possible wherein said smart material actuator is adapted such that the mechanically-amplified movement of said smart material actuator is more than ten times the amount of expansion of said smart material device; and wherein said smart material actuator is adapted such that the mechanically-amplified movement of said smart material actuator is more than one hundred times the amount of expansion of said smart material device.

The present invention is not limited to the specific embodiments or ranges discussed herein. Other variations and embodiments of the present invention will be apparent to those of ordinary skill in the art in light of this description (including the incorporated references), all of which are within the scope of the present invention.

I claim:

1. A mass flow controller comprising:
(a) a body having an inlet and an outlet;
(b) a sensor adapted to sense the flow of material out of said outlet;
(c) a controller adapted to receive a signal from said sensor;
(d) a proportional valve operatively connected between said inlet and said outlet;
(d) a mechanically-amplified smart material actuator electrically connected to said controller; and operatively connected to said proportional valve, said actuator comprising a smart material device, a compensator, a movable supporting member, at least two mechanical webs, at least two actuating arms, and a second stage assembly connected to said actuating arms wherein
(i) said compensator has a first mounting surface,
(ii) said mechanical webs comprise an inner resilient member connected to said movable supporting member, and an outer resilient member connected to an arm mounting surface;
(iii) said movable supporting member comprises a second mounting surface opposed and substantially parallel to said first mounting surface,
(iv) said actuating arms comprise a first actuating arm end attached to one said arm mounting surface and an opposed second actuating arm end;
(v) said smart material device is affixed within said compensator, between said first mounting surface and said second mounting surface;
(vi) said second stage assembly comprises at least one second stage resilient member having a first second stage resilient member end attached to said second actuating arm end and a second second stage resilient member end attached to a second stage mounting block;
whereby application of an electrical potential by said controller causes said smart material device to expand substantially without angular movement, thereby urging said movable supporting member away from said first mounting surface and causing said resilient members to flex, thereby moving said actuating arms toward said smart material device, thereby causing said second stage resilient members to urge said second stage mounting block in a direction substantially parallel to said smart material device such that motion of said second stage mounting block is across a distance greater than the expansion of said smart material device and adjusting said proportional valve to increase or decrease the flow of material out of said outlet based on said signal.

2. The mass flow controller of claim 1 wherein said actuator comprises two actuating arms.

3. The mass flow controller of claim 1 wherein said actuator comprises three actuating arms.

4. The mass flow controller of claim 1 wherein said actuator comprises more than three actuating arms.

5. The mass flow controller of claim 1 wherein said second stage mounting block is integral with said second stage resilient members.

6. The mass flow controller of claim 1 wherein said second stage mounting block is mechanically attached to said second stage resilient members.

7. The mass flow controller of claim 1 wherein the angle between said actuating arms and said second stage resilient members is greater than ninety degrees such that activation of said actuator causes said second stage mounting block to move away from said smart material device.

8. The mass flow controller of claim 1 wherein the angle between said actuating arms and said second stage resilient members is less than ninety degrees such that activation of said actuator causes said second stage mounting block to move toward said smart material device.

9. The mass flow controller of claim 1 wherein
(a) said proportional valve comprises a plunger operatively connected to a diaphragm;
(b) said plunger has a first plunger end in operative mechanical connection with said second stage mounting block and a second plunger end in operative mechanical connection with said diaphragm; and
(c) said diaphragm forms a portion of a plenum;
whereby said plenum volume may be adjusted by causing said actuator to compress said plunger, thereby adjusting the rate of flow of material through said proportional valve.

10. The mass flow controller of claim 9 wherein said diaphragm is formed of metal.

11. A mass flow controller comprising:
(a) a body having an inlet and an outlet;
(b) a sensor adapted to sense the flow of material out of said outlet;
(c) a controller adapted to receive a signal from said sensor;
(d) a mechanically-amplified smart material actuator electrically connected to said controller;
(e) a semi-spherical second stage operatively connected to said actuator and adapted to form a portion of a plenum having adjustable volume, said plenum being operatively connected to said inlet and said outlet;
wherein said controller causes said actuator to adjust the volume of said plenum based on said signal from said sensor whereby said mass flow controller is adapted to control a flow of material from said inlet through said outlet.

12. The mass flow controller of claim 11 wherein said actuator comprises a smart material device, a compensator, a movable supporting member, at least two mechanical webs, at least two actuating arms, and a second stage assembly connected to said actuating arms wherein
(a) said compensator has a first mounting surface,
(b) said mechanical webs comprise an inner resilient member mechanically connected to said movable supporting member, and an outer resilient member connected to an arm mounting surface;
(c) said movable supporting member comprises a second mounting surface opposed and substantially parallel to said first mounting surface;
(d) said actuating arms comprise a first actuating arm end attached to one said arm mounting surface and an opposed second actuating arm end;
(e) said smart material device is affixed within said compensator, between said first mounting surface and said second mounting surface; and
(f) said semispherical second stage comprises a semi-spherical diaphragm operatively attached to said second actuating arm ends.

13. The mass flow controller of claim 11 wherein said actuator comprises three actuating arms.

14. The mass flow controller of claim 11 wherein said actuator comprises more than three actuating arms.

15. A mass flow controller comprising:
(a) a body having an inlet and an outlet;
(b) a sensor adapted to sense the flow of material out of said outlet;
(c) a controller adapted to receive a signal from said sensor;
(d) a mechanically-amplified smart material actuator electrically connected to said controller, said smart material actuator comprising a smart material device and being adapted such that the mechanically-amplified movement of said smart material actuator is more than five times the amount of expansion of said smart material device; and
(e) a proportional valve mechanically connected to said actuator and being operatively connected to said inlet and said outlet;
wherein said controller causes said actuator to adjust said valve based on said signal from said sensor whereby said mass flow controller is adapted to control a flow of material from said inlet through said outlet.

16. The mass flow controller of claim 15 wherein said smart material actuator is adapted such that the mechanically-amplified movement of said smart material actuator is more than ten times the amount of expansion of said smart material device.

17. The mass flow controller of claim 15 wherein said smart material actuator is adapted such that the mechanically-amplified movement of said smart material actuator is more than one hundred times the amount of expansion of said smart material device.
